(19) United States
(12) Patent Application Publication
(10) Pub. No.: US 2010/0332785 A1
(43) Pub. Date: Dec. 30, 2010

(54) MEMORY MANAGEMENT SYSTEM AND METHOD THEREOF

(75) Inventor: FEI HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/728,262

(22) Filed: Mar. 21, 2010

(30) Foreign Application Priority Data
Jun. 29, 2009 (CN) 200910303821.1

(51) Int. Cl. G06F 12/02; G06F 12/00

(52) U.S. Cl. 711/171; 711/170; 711/173; 711/E12.001; 711/E12.002

(57) ABSTRACT

A system for managing memory of an electronic device includes a storage unit, a calculation unit, a determination unit, and an allocation unit. The storage unit stores a dynamic allocation list. The calculation calculates a real time usage status of the memory and stores the real time usage status in the storage unit. The determination unit determines whether the electronic device is turned on for the first time. The allocation unit adjusts a partition of the memory according to the dynamic allocation list if the electronic device is not turned on for the first time.

### BACKGROUND

1. Technical Field

The present disclosure relates to a memory management system and a method thereof.

2. Description of Related Art

With developments in technology, portable devices such as mobile phones, personal digital assistants (PDAs), and digital still cameras (DSCs), etc. are generally used. In order to enhance the performance of the portable devices, memory management is very important.

Presently, a common method to manage the memory of portable devices allocates a capacity of a memory block and corresponding number of the memory block in advance. However, such memory management is limited to a fixed capacity and number of memory blocks. Efficiency is affected, with some memory blocks not large enough to be used or too large to be wasted.

### BRIEF DESCRIPTION OF THE DRAWINGS

FIG. 1 is a block diagram of a memory management system of the present disclosure utilized in a portable device.

FIG. 2 is a table illustrating adjustment of a memory partition according to usage frequency and usage peak.

FIG. 3 is a flowchart illustrating one embodiment of a method for dynamic memory management.

### DETAILED DESCRIPTION

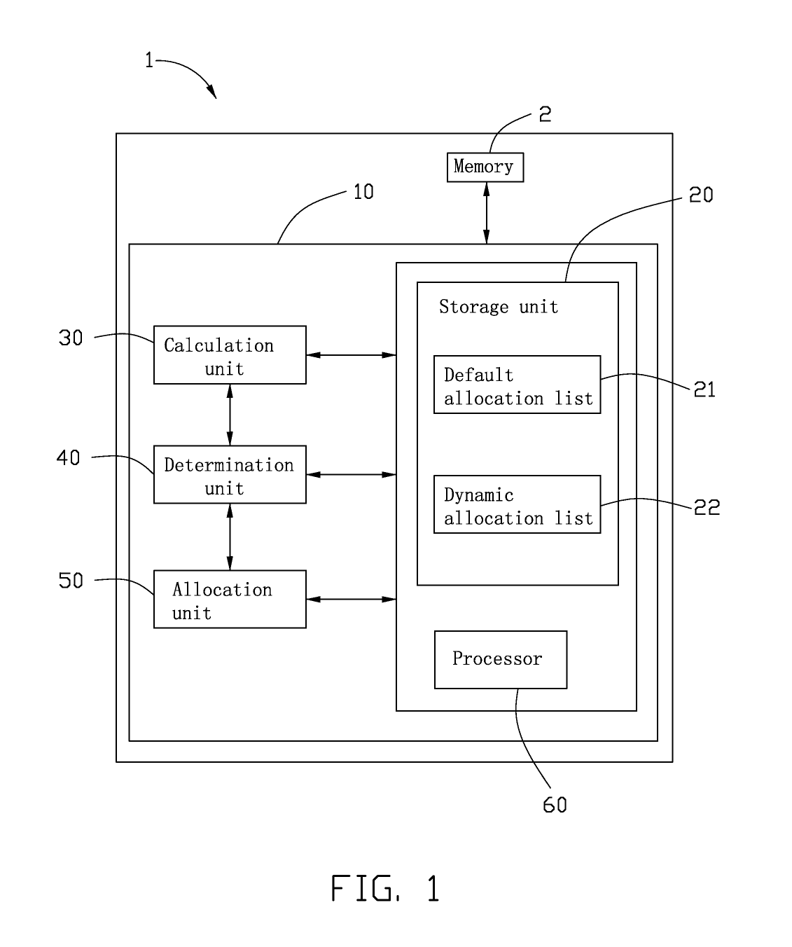

FIG. 1 is a block diagram of a memory management system 10 of the present disclosure utilized in a portable device 1. The system 10 provides an efficient memory management service for different programs to better utilize memory use and execution efficiency of programs. The system 10 includes a storage unit 20, a calculation unit 30, a determination unit 40, an allocation unit 50, and a processor 60. The processor 60 may execute one or more programs stored in the storage unit 20 for the calculation unit 30, the determination unit 40, and the allocation unit 50.

In general, the word “unit” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

The storage unit 20 stores a default allocation list 21 and a dynamic allocation list 22. The calculation unit 30 is operable to calculate a real time usage status of a memory 2 of the portable device 1 and store the real time usage status in the storage unit 20. The memory 2 may be a random access memory (RAM) or a flash memory, for example. The determination unit 40 is operable to determine whether the electronic device 1 is turned on for the first time. The allocation unit 5 is operable to allocate memory blocks in a partition of the memory 2 according to the default allocation list 21 if the electronic device 1 is turned on for the first time, and to adjust the partition of the memory 2 according to the dynamic allocation list 22 if the electronic device 1 is not turned on for the first time. The term, “allocation list” means a list of allocated memory blocks in the partition of the memory for different programs.

The real time usage status of the memory 2 includes the usage peak and the usage frequency of the memory blocks. The allocation unit 50 updates the dynamic allocation list 22 based on the real time usage status of the memory 2 before the electronic device 1 is turned off.

To adjust the partition of the memory 2 according to the dynamic allocation list 22 is explained as follows. The allocation unit 50 divides the usage peak of the memory block by a constant k to obtain a quotient, which is defined as a number of memory blocks after adjusting the partition. After obtaining the number of memory blocks after adjusting the partition, the calculation unit 30 calculates a surplus memory capacity after adjusting the partition, which is how much memory is left after adjusting the partition. The determination unit 40 determines N memory blocks with usage frequencies ranked top N, where N is a default value. The allocation unit 50 allocates the surplus memory capacity to the N memory blocks based on the usage frequencies.

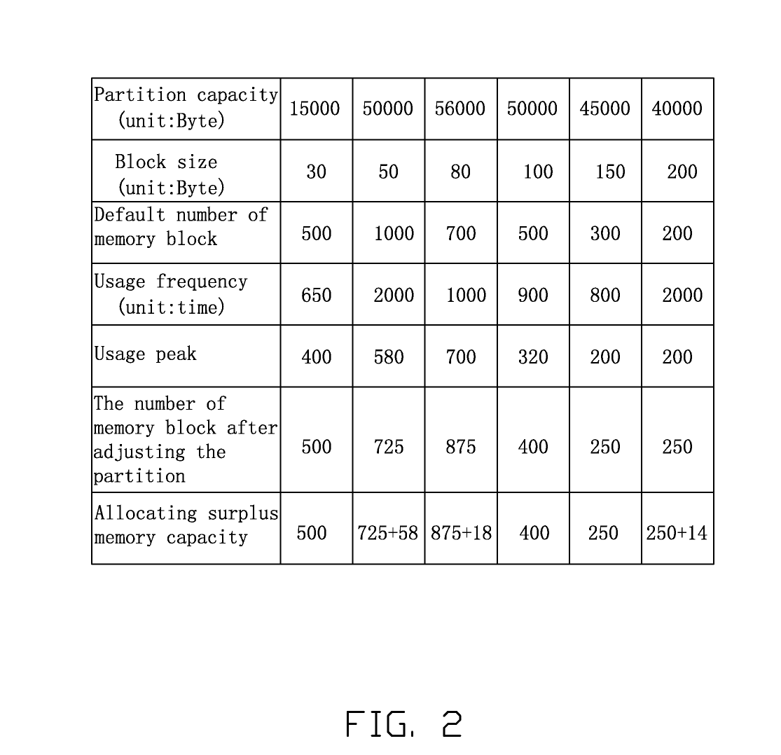

FIG. 2 is a table illustrating adjustment of a memory partition according to the usage frequency and the usage peak. In one exemplary embodiment, the default number of memory blocks with 30 bytes, 50 bytes, 80 bytes, 100 bytes, 150 bytes, and 200 bytes can respectively be 500, 1000, 700, 500, 300, and 200. Total memory capacity is 256000 bytes.

Dynamic memory management is accomplished by the formula as follows:

number of memory blocks after adjusting the partition=usage peak of memory block/k, where 0<k<1″.

The number of memory blocks after adjusting the partition may be more than the usage peak of memory blocks to be spared. k can not be less than 0.5, otherwise the number of memory blocks after adjusting the partition will be twice as many as the usage peak of the memory blocks. Once the number of memory blocks after adjusting the partition is twice the usage peak of memory blocks, the capacity after adjusting the partition will exceed the total memory capacity. In the embodiment, k is defined as 0.8.

For example, as shown in FIG. 2, the default number of memory blocks of 30 bytes is 500 and the usage peak of the memory block with 30 bytes is 400. If the electronic device 1 is not turned on for the first time, the number of memory blocks with 30 bytes is adjusted to 500 according to the formula. The default number of memory blocks with 50 bytes is 1000 and the usage peak of the memory block with 50 bytes is 580. The number of memory blocks with 50 bytes is adjusted to 725. Similarly, the number of memory blocks with 80 bytes, 100 bytes, 150 bytes, and 200 bytes is respectively adjusted to 875, 400, 250, and 250.

After adjusting the number of each memory block, the capacity of the memory block is 248750 bytes and surplus memory capacity is 7250 bytes. The usage peak of memory block with 50 bytes, 200 bytes, and 80 bytes is ranked top 3 and a ratio of each usage frequency of the memory block with 50 bytes, 200 bytes, and 80 bytes is 2:2:1. The surplus capacity, that is, 7250 bytes, is allocated to the 3 memory blocks according to the ratio. The memory block with 50 bytes may further gain 2900 bytes, equaling 58 memory blocks with 50 bytes. Similarly, the memory block with 200 bytes and 80 bytes may respectively gain 14 memory blocks of 200 bytes and 18 memory blocks of 80 bytes.

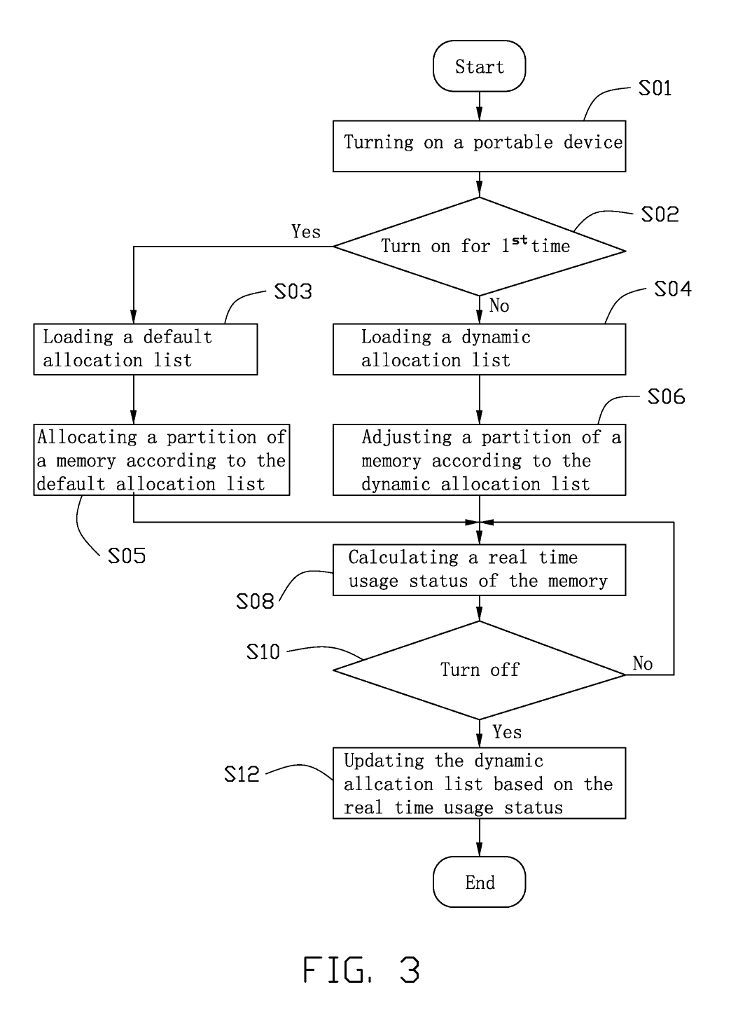

FIG. 3 is a flowchart illustrating one embodiment of a method for dynamic memory management. Depending on the embodiment, additional blocks in the flow of FIG. 3 may be added, others removed, and the ordering of the blocks may be changed.

In block S01, the portable device 1 is turned on. In block S02, the determination unit 40 determines whether the electronic device 1 is turned on for the first time.

In block S03, the allocation unit 50 loads the default allocation list 21 if the portable device 1 is turned on for the first time. In block S05, the allocation unit 50 allocates the partition of the memory 2 according to the default allocation list 21.

If the portable device 1 is not turned on for the first time, in block S04, the allocation unit 50 loads the dynamic allocation list 22. In block S06, the allocation unit 50 allocates the partition of the memory 2 according to the dynamic allocation list 22. The dynamic allocation list 22 is accomplished by the formula:

number of memory blocks after adjusting the partition=usage peak of memory block/k, where 0<k<1″.

In block S08, the calculation unit 30 calculates the real time usage status of the memory 2. In block S10, the determination unit 40 determines whether the electronic device 1 is turned off.

If the electronic device 1 is not turned off, block S08 is repeated. If the electronic device 1 receives the order to turn off, in block S12, the allocation unit 50 updates the dynamic allocation list 22 based on the real time usage status.

The present disclosure adjusts dynamically partition of a memory according to the real time usage status so that the memory of an electronic device can be used efficiently.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for managing a memory of an electronic device, the system comprising:
a storage unit storing a dynamic allocation list;
at least one processor;
one or more programs stored in the storage unit and being executable by the at least one processor;
a calculation unit operable to calculate a real time usage status of the memory and store the real time usage status in the storage unit;
a determination unit operable to determine whether the electronic device is turned on for the first time; and
an allocation unit operable to adjust a partition of the memory according to the dynamic allocation list if the electronic device is not turned on for the first time.

2. The system of claim 1, wherein the storage unit further comprises a default allocation list, and the allocation unit is further operable to allocate the partition of the memory according to the default allocation list if the electronic device is turned on for the first time.

3. The system of claim 1, wherein the real time usage status of the memory comprises a usage peak and a usage frequency of a memory block in the partition of the memory.

4. The system of claim 3, wherein the allocation unit is further operable to update the dynamic memory list based on the real time usage status of the memory before the electronic device is turned off.

5. The system of claim 3, wherein the allocation unit is further operable to divide the usage peak of the memory block by a constant K to obtain a quotient as a number of memory blocks, wherein 0<K<1.

6. The system of claim 5, wherein the calculation unit is further operable to calculate a surplus memory capacity after the number of memory blocks is obtained.

7. The system of claim 6, wherein the determination unit is further operable to determine N memory blocks with usage frequencies ranked top N, wherein N is a default value.

8. The system of claim 7, wherein the allocation unit is further operable to allocate the surplus memory capacity to the N memory blocks based on the usage frequencies.

9. A computer-implemented method for managing a memory of an electronic device, the method comprising:
determining whether the electronic device is turned on for the first time;
adjusting a partition of the memory according to a dynamic allocation list stored in the electronic device when the electronic device is not turned on for the first time;
calculating a real time usage status of the memory; and
updating the dynamic allocation list based on the real time usage status of the memory before the electronic device is turned off.

10. The method of claim 9 further comprising:
allocating the partition of the memory according to a default allocation list stored in the electronic device when the electronic device is turned on for the first time.

11. The method of claim 9, wherein the real time usage status of the memory includes a usage peak and a usage frequency of a memory block.

12. The method of claim 11, wherein the step of adjusting the partition of the memory further comprises:
dividing the usage peak of the memory block by a constant K to obtain a quotient as an number of memory blocks, wherein 0<K<1;
calculating a surplus memory capacity after adjusting the partition;
determining N memory blocks with usage frequencies ranked top N, wherein N is a default value; and
allocating the surplus memory capacity to the N memory blocks based on the usage frequencies.

13. A storage medium having stored thereon instructions that, when executed by a processor, causing the processor to perform a method for managing a memory of an electronic device, wherein the method comprises:
determine whether the electronic device is turned on for the first time;
adjust a partition of the memory according to a dynamic allocation list stored in the electronic device when the electronic device is not turned on for the first time;
calculate a real time usage status of the memory; and
update the dynamic allocation list based on the real time usage status of the memory before the electronic device is turned off.

14. The storage medium of claim 13, wherein the method comprises:
allocate the partition of the memory according to a default allocation list stored in the electronic device when the electronic device is turned on for the first time.

15. The storage medium of claim 13, wherein the real time usage status of the memory includes a usage peak and a usage frequency of a memory block.

16. The storage medium of claim 15, wherein the step of adjust the partition of the memory further comprises:
divide the usage peak of the memory block by a constant K to obtain a quotient as an number of memory blocks, wherein 0<K<1;
calculate a surplus memory capacity after adjusting the partition;
determine N memory blocks with usage frequencies ranked top N, wherein N is a default value; and
allocate the surplus memory capacity to the N memory blocks based on the usage frequencies.
